(19) United States
(12) Patent Application Publication
(10) Pub. No.: US 2015/0038201 A1
(43) Pub. Date: Feb. 5, 2015

(54) Combine harvester comprising a chopping mechanism

(71) Applicant: CLAAS SELBSTFAHRENDE ERNTEMASCHINEN GMBH, Harsewinkel (DE)

(72) Inventors: Joern BRINKMANN, Harsewinkel (DE); Christian BEULKE, Harsewinkel (DE); Dieter AMSBECK, Harsewinkel (DE); Juergen NOLLMAN, Versmold (DE); Dirk DUCRÉE, Olsberg (DE)

(21) Appl. No.: 14/445,313

(22) Filed: Jul. 29, 2014

(30) Foreign Application Priority Data
Aug. 1, 2013 (DE) 10 2013 108 292.0

(51) Int. Cl. A01F 29/00

(52) U.S. Cl. CPC A01F 29/00
USPC 460/112

(57) ABSTRACT

A combine harvester is configured with a chopping mechanism for chopping crop that includes a cutting cylinder equipped with knives, a knife carrier equipped with counter-knives and a friction concave plate and, downstream thereof a rasp bar. The knife carrier and the friction concave plate are each swivellable about a swivel axis, which enables the knife carrier and the friction concave plate to be moved into a position in which the counter-knives, the rasp bar or both extend at least partially into a crop stream passing through the chopping mechanism. The knife carrier and the friction concave plate are each adjusted using an actuator without the use of tools.

### CROSS-REFERENCE TO A RELATED APPLICATION

The invention described and claimed hereinbelow is also described in German Patent Application DE 10 2013 108292.0, filed on Aug. 1, 2013. The German Patent Application, the subject matters of which is incorporated herein by reference, provides the basis for a claim of priority of invention under 35 U.S.C. 119(a)-(d).

### BACKGROUND OF THE INVENTION

The present invention relates to a combine harvester comprising a chopping mechanism for chopping crop, which has a chopper drum equipped with knives, a knife carrier and a rasp bar.

Document DE 1 896 312 U1 makes known a device for chopping hay or straw-like material, which comprises a rotating rotor equipped with knives. The knives thereof pass between a plurality of counter-knives arranged in a row. The counter-knives are disposed on a common carrier, which can swivel about the longitudinal axis thereof, in order to permit adjustment of the slant of the counter-knives. The carrier is adjusted by a lever arrangement, which is secured by a nut against displacement during operation resulting from vibrations of the device.

### SUMMARY OF THE INVENTION

The present invention overcomes the shortcomings of known arts, such as those mentioned above.

To that end, the present invention provides a simple and adjustable knife carrier and the rasp bar that ensure optimal chopping quality.

In an embodiment, the invention provides a combine harvester with a chopping mechanism for chopping crop comprising a cutting cylinder equipped with knives, a knife carrier equipped with counter-knives and a friction concave plate and, downstream thereof, a rasp bar. The knife carrier and the friction concave plate are each swivellable about a swivel axis, thereby enabling these to be moved into a position in which the counter-knives and/or the rasp bar extend at least partially into a crop stream passing through the chopping mechanism. The knife carrier and the friction concave plate are each adjusted by an actuator (37), without the use of tools.

The tool-free adjustment of the knife carrier and the friction concave plate has the advantage for the operator of the combine harvester that he/she can rapidly and easily adjust the chopping mechanism to changing harvesting conditions, such as a change in crop type or to crop moisture content that varies during the harvesting process. All that is required is tool-free actuation of the actuators in order to change the position of the knife carrier and the counter-knives carried thereby, and of the friction concave plate in order to activate or deactivate the rasp bar, in order to influence the chopping quality.

Preferably, the knife carrier and the friction concave plate are adjusted independently of one another. Given that the adjustability is mutually independent, the friction concave plate can be adjusted in moist conditions, in particular, such that the rasp bar is not engaged with the crop stream passing through the chopping mechanism, thereby saving energy and preventing a possible crop backlog in the chopping mechanism, while the setting of the knife carrier remains unchanged.

In an embodiment, the actuators are each designed as a manually actuatable lever, which is disposed directly on the rotational axis of the knife carrier or the friction concave plate. Given that the particular lever acts directly on the rotational axis of the knife carrier or the friction concave plate, there is no need to provide an additional transfer of force and movement by means of intermediately-connected lever elements.

As an alternative, the actuators are designed as a cylinder that is acted upon with a fluid. This cylinder may take the form of a hydraulically or pneumatically actuatable cylinder. A combination of a hydraulically actuatable cylinder and a pneumatically actuatable cylinder as the actuators for the knife carrier and the friction concave plate is also feasible.

To this end, the displacement path of the particular cylinder is limited by a limiting means. A spring bolt can be used as the limiting means, for example, which limits the displacement path of the particular cylinder to two definite positions. While the rasp bar can be transferred, via displacement of the friction concave plate by the associated cylinder (preferably from the active position thereof, in which this rasp bar is engaged with the crop stream, into an inactive position, in which the rasp bar is not engaged with the crop stream), it makes sense, in terms of the adjustment of the knife carrier, to be capable of controlling different positions. For example, by the limiting means designed as a spring bolt, the displacement path of the cylinder actuated by the counter-knife bar is selectively repositioned into positions between swivelled halfway inward and swivelled entirely outward or between swivelled halfway inward or swivelled entirely inward. This repositioning also can take place without the use of tools, given that the limiting means is designed as a spring bolt.

In an embodiment, the displacement path of the cylinder is detectable by an angular sensor. The particular swivel angle of the knife carrier and the friction concave plate, about which the knife carrier and friction concave plate are swivelled by the respective cylinder, is detected by the angular sensor. When the particular desired position is reached, the actuation of the respective cylinder is interrupted in order to hold the knife carrier or the friction concave plate in the position that is reached. This makes it possible to easily achieve a stepless adjustment of the knife carrier and the friction concave plate and/or to activate and deactivate the rasp bar.

According to an alternative embodiment for the stepless adjustment, the actuators are designed as an electromechanical drive. This can be an electromechanical linear drive, the translatory movement of which is converted to a rotational movement of the knife carrier or the friction concave plate about the respective swivel axis.

In addition, the combine harvester comprises a control device, by which the actuator designed as a cylinder and/or a linear drive is controlled. The control device is operated by an operator in order to implement the desired adjustment of the knife carrier and/or friction concave plate depending on prevailing harvesting conditions, such as crop type or crop moisture, or other parameters. The adjustment is implemented on the basis of values the operator knows from experience in operating a combine harvester, which generally differ from operator to operator. Given that an operator can control the actuators for adjusting the knife carrier and/or the friction concave plate by the control device, it is possible to directly influence the efficiency of the chopping process and the quality thereof.

Advantageously, the actuators are controlled independently of other working assemblies of the combine harvester. The advantage of controlling the actuators by the control device is that the setting of the knife carrier and/or the friction concave plate are adjusted while the harvesting process is underway. The harvesting process is not interrupted, as is the case when implementing a manual adjustment of the knife carrier and/or friction concave plate with the use of tools in particular. Instead, the operator implements the adjustment under existing operating conditions of the combine harvester, i.e., independently of the operating parameters of the other working assemblies of the combine harvester, thereby enabling the operator to draw conclusions regarding the extent to which the implemented adjustment of the setting of the knife carrier and/or friction concave plate has led to the desired result.

Advantageously, the control device can be configured to automatically control the knife carrier and the friction concave plate. This makes it possible to simplify handling and therefore relieve the operator. The control device is designed to enable the operator to choose between automatic modes, wherein one mode is designed to maintain an optimal chopping quality and another mode designed for energy-efficient operation of the chopping mechanism. The operator is therefore enabled to decide on his own, within the framework of the automatic adjustment of the knife carrier and/or the friction concave plate, whether this places higher value on optimal chopping quality or energy efficiency under changing environmental and working conditions.

In particular, the knife carrier and the friction concave plate can be controlled depending on crop properties and/or operating parameters. As a result, the crop to be chopped is processed more efficiently. In addition, a uniform chopping quality is obtained. The operator specifies the crop properties and the operating parameters via input into the control device, for example, by making a selection from a list of crop types or directly entering values that represent operating parameters.

To this end, the combine harvester comprises a sensor system designed to detect crop properties and/or operating parameters, wherein this sensor system is operatively connected to the control device. To this end, the sensor system is designed as a sensor for detecting the moisture content of crop, the signals of which are forwarded by a signal transmission line to the control device, which evaluates these signals. On the basis of this evaluation, the control device can then actuate the actuators for adjusting the knife carrier and the friction concave plate in order to adjust the setting thereof to changing conditions.

Preferably, the sensor system comprises an image recording unit. An image recording unit offers the advantage of crop detection, for example, in order to implement the settings of the knife carrier and/or friction concave plate on the basis of this detection. The image recording unit also can detect and evaluate the quality of the chopped crop output by the chopping device, in order to control and/or regulate the respective settings of the knife carrier and/or the friction concave plate on the basis thereof, by adapting the actuators to the specification by an operator depending on the quality of the chopped crop that is detected.

As an alternative or in addition thereto, the sensor system comprises a device for detecting moisture. A related moisture sensor is disposed in the feed rake of the combine harvester in order to detect the moisture content of the crop at the earliest possible point in time. The control device therefore has a sufficient amount of time to adjust the settings of the knife carrier and/or the friction concave plate appropriately in reaction to a moisture content of the crop that is changing significantly.

Furthermore, the combine harvester comprises a driver's cab, in which an input and output unit is disposed, wherein this input and output unit is connected to the control device. This input and output unit is used as a communication interface with the control device. The input and output unit makes it possible for an operator to obtain information on current operating parameters, for example, as well as to specify parameters to be adhered to, such as the desired chopping quality, or for the operator to directly set operating parameters that are based on the harvest conditions.

### BRIEF DESCRIPTION OF THE DRAWINGS

Further features and advantages of the invention will become apparent from the description of embodiments that follows, with reference to the attached figures, wherein:

FIG. 1 presents a schematic side view of a combine harvester constructed in accordance with the invention;

FIG. 2a presents a schematic representation of a chopping mechanism included in the FIG. 1 combine harvester;

FIG. 2b presents a schematic representation of the FIG. 2b chopping mechanism with the rasp bar activated;

FIG. 2c presents a schematic detailed view of the FIG. 2a chopping mechanism with the counter-knives deactivated;

FIG. 3 presents a schematic detailed view of an alternative embodiment of the chopping mechanism in the FIG. 1 combine harvester; and

FIG. 4 presents a schematic detailed view of an alternative embodiment of the chopping mechanism in the FIG. 1 combine harvester.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

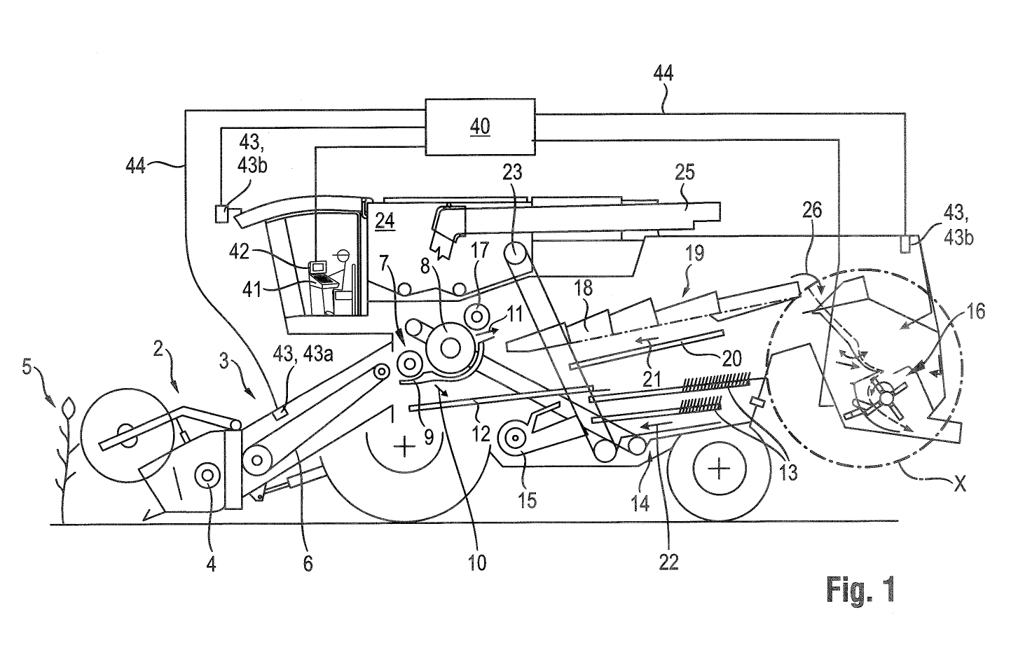

The combine harvester 1 depicted schematically in FIG. 1 accommodates, in the front region thereof, a front attachment designed as a grain-cutting device 2. The grain-cutting device 2 is connected in a manner known per se to the feed rake 3 of the combine harvester 1. The cross auger component 4 of the header 2 transfers the crop 5 picked up by this header to the feed rake 3. The feed rake transfers the crop 5 via a circulating conveyor 6 in the upper, rear region thereof to the threshing mechanism 7 of the combine harvester 1.

In the threshing mechanism 7, which comprises one cylinder or several cylinders, the crop 5 is conveyed between the cylinders 8 and a concave 9, which at least partially encloses these cylinders, thereby separating said crop into at least two partial streams 10, 11. The first partial stream 10 is substantially composed of grain, short straw, and chaff, and is conveyed directly via a grain pan 12 to a cleaning mechanism 14, which comprises various sieve levels 13. The cleaning mechanism 14 also accommodates a fan unit 15, which generates an air flow which passes through the sieve levels 13.

The second partial stream 11, which substantially comprises straw and a residual portion of grain, and which exits the threshing mechanism 7 in the rear region thereof, is directed via a straw guide cylinder 17 to a separating device 19 designed as a tray-type shaker 18. Via the oscillating motion of the tray-type shaker 18, a large portion of the grain 21 contained in the straw layer is separated on the tray-type shaker 18 and is transferred via a return pan 20 and the grain pan 12 to the cleaning mechanism 14. The separating device 19 also may be designed, in a known manner, as an axial separating device comprising one or more separating rotors.

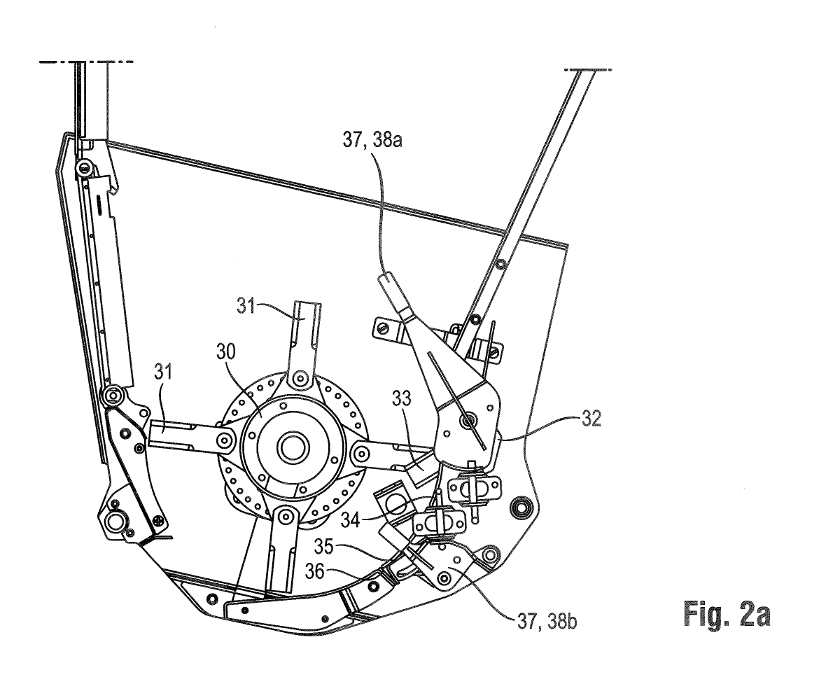

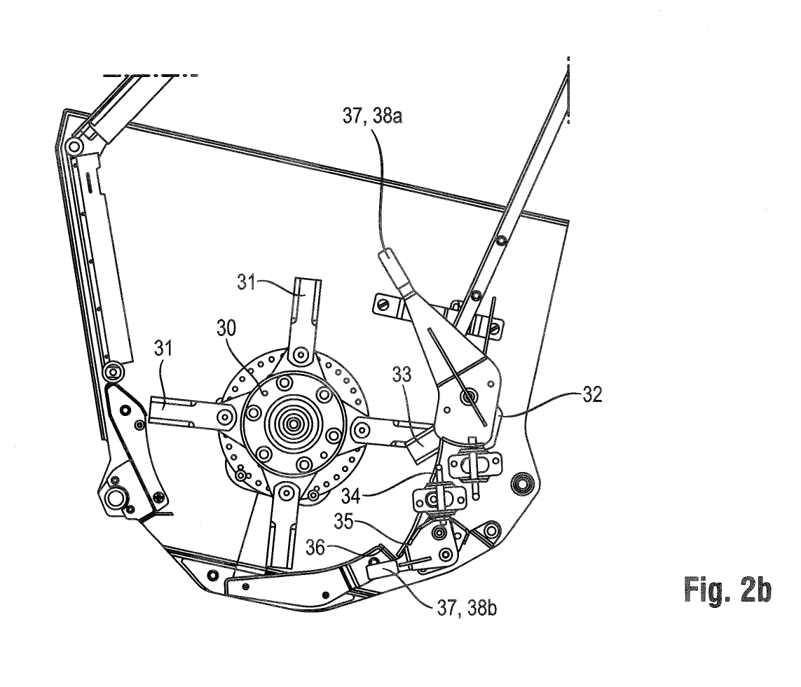

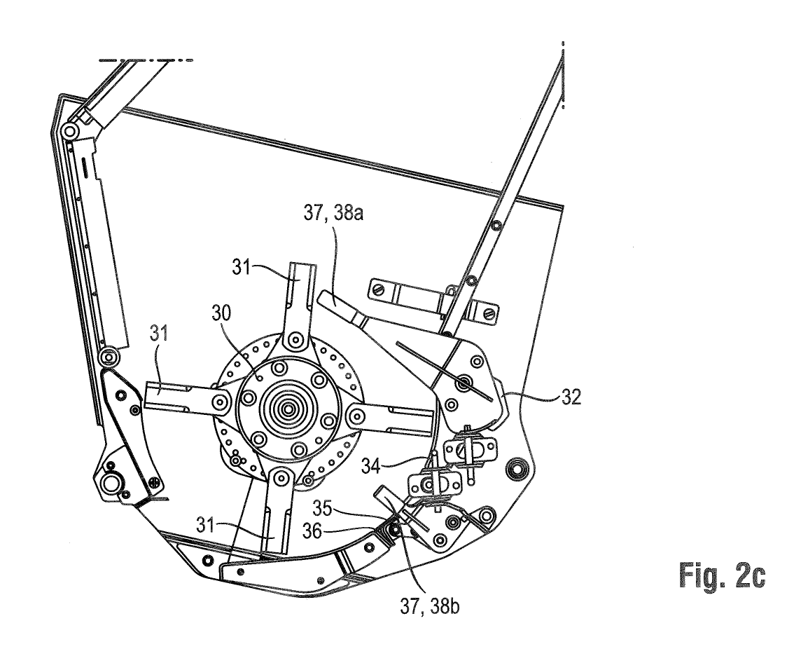

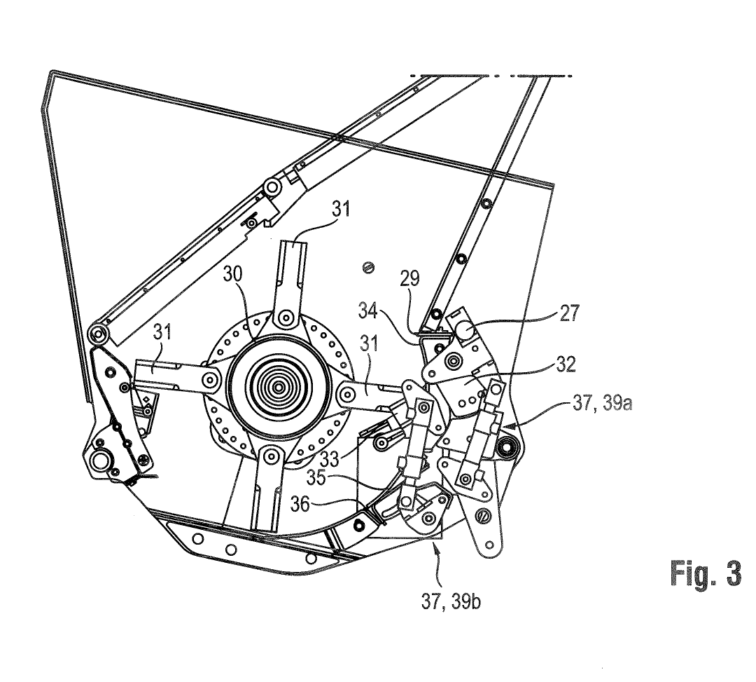

Finally, in the cleaning mechanism 14, a cleaned grain flow 22 obtained from the various crop-material flows 10, 21 introduced into the cleaning mechanism 14 is conveyed by conveyor elevators 23 into a grain tank 24 and is stored therein for the interim. The grain tank 24 is usually emptied by a grain tank unloading conveyor 25. By the oscillating movement of the straw walker racks, the crop 11 transferred from the threshing parts 7 to the tray-type shaker 18 is conveyed thereon in the form of a series of throwing movements and finally, in the rear region of the tray-type shaker 18, is transferred as a crop stream 26 substantially containing only straw in the direction of a downstream chopping mechanism 16. The further handling of the crop stream 26 is described in the following by reference to FIGS. 2a, 2b, 2c and 3.

The representation in FIG. 2a shows a schematic detailed view of the chopping mechanism 16. The chopping mechanism 16 comprises a cutting cylinder 30 having free-swinging knives 31 disposed thereon, and, as viewed in the direction of crop conveyance, a cross cutter 29, a knife carrier 32 (on which the counter-knives 33 are disposed), which can be engaged, in sections, with the free-swinging knives 31 on the cutting cylinder 30, a separate plate section 34, which extends, in sections, in the circumferential direction of the cutting cylinder 30 and has slots in the surface thereof which extend, in sections, in the circumferential direction, behind which the knife carrier 32 having the counter-knives 33 is disposed, wherein these counter-knives can pass through the slot, a friction concave plate 35 and a rasp bar 36, which adjoins the friction concave plate as viewed in the circumferential direction. An actuator 37 is assigned to the knife carrier 32 and to the friction concave plate 35, in order to permit these to be adjusted independently of one another without the use of tools.

As is clear from the representation in FIG. 2a, the plate section 34, the friction concave plate 35 and the rasp bar 36 substantially extend coaxially to the rotational axis of the cutting cylinder 30. These elements of the chopping mechanism 16 are used to guide and influence the chopping process during the processing of the crop by the chopping mechanism 16, wherein this crop has been transferred by the tray-type shaker 18. Different measures are implemented in order to influence the chopping process and, therefore, the quality of the chopped crop, as explained in the following.

For example, the straw can be cut using a free cut, i.e., without support from the counter-knives 33. To this end, the counter-knives 33 are disengaged from the free-swinging knives 31 by swivelling the knife carrier 32 disposed behind the plate section 34 in the radial direction to the extent that the knives have been fully retracted relative to the surface of the plate section 34, as depicted in FIG. 2c. This position of the knife carrier 32 results in a long chopping length and is used, for example, in the processing of corn or rapeseed as crop 5 by the combine harvester 1.

The position of the knife carrier 32 represented in FIG. 2a is used in the processing of grain or rice as crop 5 by the combine harvester 1. The chopping length is significantly shorter in this position. Intermediate positions can also be selected, in which the counter-knives 33 extend outwardly by different lengths relative to the surface of the plate section 34, which results in different chopping lengths.

The chopping length also is influenced by swivelling of the friction concave plate 35. Swivelling the friction concave plate 35 in the radial direction toward the cutting cylinder 30 or away therefrom results in a longer chopping length or a shorter chopping length, respectively. By the swivelling, the rasp bar 36 disposed downstream of the friction concave plate 35 as viewed in the direction of crop flow is engaged with the crop stream to a different extent.

A distinction is made here as well, depending on the type of crop, in terms of the adjustment of the position of the friction concave plate 35. For corn or rice, the friction concave plate 35 is swivelled inwardly in the direction of the cutting cylinder 30 so far that the chopping length is very long, as shown in FIG. 2a, while, in the processing of grain, the friction concave plate 35 is positioned with great radial separation from the cutting cylinder 30 in order to obtain the shortest possible cutting length, as is evident from the representation in FIG. 2b. The greater the radial separation of the friction concave plate 35 from the cutting cylinder 30, the greater the influence is that the rasp bar 36 can exert on the crop stream to be chopped, with which the rasp bar 36 can be increasingly engaged. Various positions also can be set in the adjustment of the friction concave plate 35 in order to obtain different chopping lengths, by engaging the rasp bar 36 with the crop stream to a different extent.

According to the embodiment shown in FIGS. 2a-2c, the actuator 37 is designed as a lever 38a, 38b in each case, which act on an outer end of the rotational axis of the knife carrier 32 and the friction concave plate 35, respectively, in order to swivel these.

The lever 38a disposed on the knife carrier 32 is designed such that the lever can assume a limited number of positions. This enables the knife carrier 32 and, therewith, the counter-knife 33, to be transferred between a position swivelled completely inward and a position swivelled completely outward into at least one intermediate position, in which the counter-knives 33 extend only partially through slots in the plate section 34.

The friction concave plate 35 can be swivelled inwardly or outwardly by the lever 38b in the same manner, thereby enabling the rasp bar 36 to be engaged with the crop stream when the friction concave plate 35 is in the swivelled-inward position, but not when the friction concave plate 35 is in the swivelled-outward position. To this end, projections can be disposed on the levers 38a, 38b on the walls thereof enclosing the chopping mechanism 16, wherein these projections engage in corresponding recesses in the wall and define the possible positions of the lever 38a, 38b. The adjustment by the levers 38a, 38b takes place without the use of tools, although the operator of the combine harvester 1 must leave the driver's cab for this purpose. In order to allow the manual, albeit tool-free, handling to become superfluous, it is provided according to the embodiment depicted in FIG. 3 that the actuator is designed as a hydraulic cylinder 39a, 39b in each case, which can be controlled via a control device 40, which can be used for the control and/or regulation of a few or all working assemblies of the combine harvester 1.

The control device 40 comprises an input unit 41, such as a keyboard, and an output unit 42 in the form of a display device, or an input and output unit designed as a touchscreen. These communication interfaces 41, 42 enable the operator of the combine harvester 1 to communicate with the control device 40, i.e., to display current operating parameters of the working assemblies and to adapt corresponding operating parameters to changing harvesting conditions by a targeted input. The mutually independent controllability of the hydraulic cylinders 39a, 39b from within the driver's cab also has the advantage that the operator can react more quickly to changing harvesting conditions, such as moist points in a field to be harvested, by the operator deactivating the displacement of the friction concave plate 35 in the direction of the cutting cylinder 30, for example. The rasp bar 36 is deactivated by swivelling the friction concave plate 35 in the direction of the cutting cylinder 30 to the extent that the rasp bar 36 no longer extends into the crop stream. This allows the power uptake of the chopping device 16 to be reduced temporarily, i.e. for the duration of the passage over the moist point on the field, and to reduce the risk of a crop blockage, which can result from the processing of very moist crop.

After this point has been passed, the operator can reactivate the rasp bar 36, either partially or entirely, via a corresponding control of the friction concave plate 35, i.e., by moving the friction concave plate 35 away from the cutting cylinder 30 such that the rasp bar 36 extends partially or entirely into the crop stream. The displacement of at least one knife carrier 32 can be limited by a limiting element, which is designed as a spring bolt 27. The spring bolt 27 limits the displacement path of the hydraulic cylinders 39a, 39b, wherein preferably two positions of the spring bolt 27 are provided, which respectively permit the setting of two different positions of the knife carrier 32. The displacement path can be limited, for example, such that the knife carrier 32 can assume, by the spring bolt 27, either a position swivelled halfway inward or swivelled entirely outward, or a position swivelled halfway inward or swivelled entirely inward.

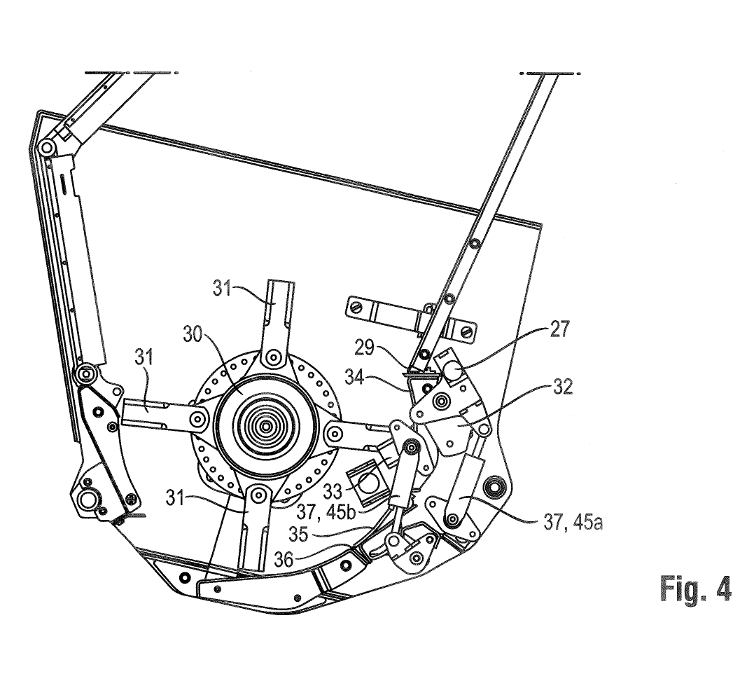

The representation in FIG. 4 shows an embodiment in which the actuator 37 is designed as an electromechanical linear drive 45a, 45b. The actuator 37 as an electromechanical linear drive 45a, 45b has the advantage that the knife carrier 32 and the friction concave plate 35 can be steplessly adjusted. This also can be achieved, in the same manner, by the hydraulic cylinders 39a, 39b when these have travel feedback.

The embodiment of the actuator 37 as hydraulic cylinders 39a, 39b or electromechanical linear drives 45a, 45b has the advantage that the position of the knife carrier 32 and/or the friction concave plate 35 can be adjusted at any time during on-going operation of the combine harvester 1. The actuator 37 can be adjusted during threshing without the need to interrupt the on-going threshing process, and the resultant success or failure of the adjustment of the knife carrier 32 and/or the friction concave plate 35 can be immediately evaluated by the operator. The operator can implement the change immediately without other parameters being changed. The fact that the harvesting operation is no longer interrupted is advantageous, in particular, since the operator merely adjusts the knife carrier 32 and/or the friction concave plate 35 or the rasp bar 36, while the remaining working parameters of the working assemblies remain unchanged.

In addition to the time savings associated therewith, the operator is provided with the opportunity to trace the effects of an implemented adjustment of the knife carrier 32 and/or friction concave plate 35 on the quality of chopped crop directly back thereto. The positions of the counter-knife carrier 32 and the friction concave plate 35 presented as examples in FIGS. 2b and 2c, which are intended to illustrate the independent adjustment of the counter-knife carrier 32 and the friction concave plate 35, also can be obtained, in a corresponding manner, by the actuators 37, which are designed as hydraulic cylinders 39a, 39b or electromechanical linear drives 45a, 45b.

In a further design stage, the operator is relieved of the procedure for adjusting the setting of the knife carrier 32 and/or the friction concave plate 35 by making a related input via the communication interface 41, 42, in that these adjustments are automatically implemented by the control device 40 and/or an additional control unit. In order to achieve this level of automation, at least one sensor 43 is disposed on the combine harvester 1, which is used to detect crop properties and/or operating parameters and to which the control device 40 and/or the additional control unit is operatively connected. For example, a sensor 43a for measuring moisture can be disposed in the feed rake 3, the signals of which are transmitted to the control device 40 via signal lines 44 and are evaluated thereby. These signals, which represent the moisture content of the crop, are utilized to automatically control the positioning of the knife carrier 32 and the friction concave plate 35 by the actuators 37, in order to obtain optical chopping quality.

A further aspect is that the knife carrier 32 and the friction concave plate 35 are adjusted depending on the type of crop. To this end, the operator specifies the type of crop to be processed to the control device 40 by making a corresponding entry via the communication interfaces 41, 42, wherein said control device selects the setting for the knife carrier 32 and the friction concave plate 35 that is most suitable for the type of crop to be processed and controls the actuators 37 accordingly for this purpose, in order to implement the particular setting. As described above, changes in the harvesting conditions that occur during the harvesting process, such as a change in the moisture, are detected by sensors and are evaluated by the control device 40, thereby ensuring that, in the automatic adjustment of the mutually independent positions of the knife carrier 32 and the friction concave plate 35 by the actuators 37, the positions are continuously adjustable. In addition, an image recording unit designed as a camera 43b is disposed in the rear region of the combine harvester 1. The camera 43b continuously records images of the crop stream 26 processed by the chopping mechanism 16. These images are transmitted via the signal line 44 to the control device 40, which evaluates these images by means of image processing software. The evaluation of the images permits conclusions to be drawn about the chopping quality obtained with the given settings of the knife carrier 32 and the friction concave plate 35. Similarly, the settings of the knife carrier 32 and/or the friction concave plate 35 are changed via the control of the actuator 37 if the chopping quality does not meet the requirements, which result, for example, from a change in the harvesting conditions that occurred during the harvesting process.

In order to ensure that changes in the harvesting conditions are detected in advance, an image recording unit designed as a camera 43b is disposed on the front side of the combine harvester 1, which records images of the crop stand as viewed in the direction of travel of the combine harvester 1. This makes it possible to identify moist points in the field to be harvested at an early point in time and to respond thereto by means of suitable measures, as described above in this context.

Instead of or in addition to one or more cameras or sensors for moisture detection, it is possible to use further sensors, such as ultrasonic sensors, laser sensors, infrared sensors, or acoustic sensors.

### List of Reference Characters

1 combine harvester

2 grain-cutting device

3 feed rake

4 cross auger component

5 crop

6 conveyor

7 threshing mechanism

8 cylinder

9 concave

10 first partial stream

11 second partial stream

12 grain pan

13 sieve level

14 cleaning mechanism

15 fan unit

16 chopping mechanism

17 straw guide cylinder

18 tray-type shaker

19 separating device

20 return pan

21 grain

22 grain flow

23 conveyor elevator

24 grain tank

25 grain tank unloading conveyor

26 crop stream

27 spring bolt

29 cross cutter

30 cutting cylinder

31 free-swinging knives

32 knife carrier

33 counter-knife

34 plate section

35 friction concave plate

36 rasp bar

37 actuator

38a lever

38b lever

39a hydraulic cylinder

39b hydraulic cylinder

40 control device

41 input unit

42 output unit

43 sensor

43a moisture sensor

43b camera

44 signal line

45 linear drive

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A combine harvester comprising a chopping mechanism for chopping crop, the chopping mechanism comprising a cutting cylinder equipped with knives, a knife carrier equipped with counter-knives and a friction concave plate and, downstream thereof, a rasp bar,
wherein the knife carrier and the friction concave plate are each swivellable about a swivel axis, thereby enabling the knife carrier and the friction concave plate to be moved into a position in which the counter-knives, the rasp bar or both extend at least partially into a crop stream passing through the chopping mechanism, and
wherein the knife carrier and the friction concave plate are adjustable using an actuator, without the use of tools.

2. The combine harvester according to claim 1, wherein the knife carrier and the friction concave plate are adjusted independently of one another.

3. The combine harvester according to claim 1, wherein the actuator is designed as a manually actuatable lever, which is disposed directly on the swivel axis of the knife carrier or the friction concave plate.

4. The combine harvester according to claim 1, wherein the actuator is a cylinder that is acted upon with a fluid.

5. The combine harvester according to claim 4, wherein a displacement path of the cylinder is limited by a limiting means.

6. The combine harvester according to claim 4, wherein the displacement path of the cylinders are detected by an angular sensor.

7. The combine harvester according to claim 1, wherein the actuator is an electromechanical linear drive.

8. The combine harvester according to claim 4, further comprising a control device utilized by the actuator in the form of the cylinder, a linear drive or both are controlled.

9. The combine harvester according to claim 8, wherein the actuator is controlled independently of other working assemblies of the combine harvester.

10. The combine harvester according to claim 8, wherein the control device is automatically controls the knife carrier and the friction concave plate.

11. The combine harvester according to claim 8, wherein the knife carrier and the friction concave plate are controlled depending on crop properties, operating parameters or both.

12. The combine harvester according to claim 8, further comprising at least one sensor for detecting crop properties, operating parameters or both, to which said sensor the control device, an additional control unit or both are operatively connected.

13. The combine harvester according to claim 12, wherein the sensor comprises an image recording unit.

14. The combine harvester according to claim 12, wherein the sensor comprises a device for detecting moisture.

15. The combine harvester according to claim 8, further comprising a driver's cab having an input unit and an output unit (41, 42) that are connected to the control device.
